(19) United States
(12) Patent Application Publication
(10) Pub. No.: US 2011/0238205 A1
(43) Pub. Date: Sep. 29, 2011

(54) MOBILE ROBOT AND METHOD FOR OBJECT FETCHING

(75) Inventors: Charles C. Kemp, Atlanta, GA (US); Zhe Xu, Seattle, WA (US); Zhengqin Fan, Atlanta, GA (US)

(73) Assignee: GEORGIA TECH RESEARCH CORPORATION, Atlanta, GA (US)

(21) Appl. No.: 13/021,300

(22) Filed: Feb. 4, 2011

Related U.S. Application Data
(60) Provisional application No. 61/301,403, filed on Feb. 4, 2010.

(51) Int. Cl. B65G 1/00; G06F 7/00

(52) U.S. Cl. 700/214; 414/590; 700/245

(57) ABSTRACT

A robot for lifting an object, including systems and methods, are herein described. One embodiment comprises a robot is disclosed having a generally planar receiving surface for receiving and holding an object. The receiving surface is lowered and raised using a vertical movement mechanism. To move the receiving surface to an appropriate location, the receiving surface and the vertical movement mechanism are connected to a mobile platform. In some exemplary embodiments, the robot can also have a sweeping mechanism to sweep an object onto at least a portion of the receiving surface. The sweeping mechanism can take various forms but in one exemplary embodiment, the sweeping mechanism is an “L”-shaped arm pivotably connected to the robot, preferably the receiving surface.

### CROSS REFERENCE TO RELATED APPLICATION

This application claims benefit under 35 U.S.C. §119(e) of U.S. Provisional Patent Application No. 61/301,403, filed Feb. 4, 2010, and entitled “Dusty Mobile Manipulator: A Remote-Controlled Mobile Robot for Object Fetching”, which is incorporated by reference as if set forth herein in its entirety.

### TECHNICAL FIELD

The present system relates generally to robotics.

### BACKGROUND

In 2005 the U.S. Census Bureau estimated that more than 3.3 million Americans have motor impairments. People with motor impairments consistently have placed a high priority on the ability to retrieve out-of-reach objects, including objects on the floor. Motor impairments can both increase the chances that an individual will drop an object, and make unassisted recovery of an object difficult or impossible. In a survey, eight people with amyotrophic lateral sclerosis (ALS) reported dropping objects an average of 5.5 times a day with a self-reported mean object retrieval time of 9.4 minutes (SD=25.4 min). The absence of a caregiver can lead to especially long recovery times, including one report of a two hour wait in a small week-long study. Service robots potentially could help people with motor impairments retrieve dropped objects, and thereby gain greater independence.

### BRIEF SUMMARY OF THE DISCLOSURE

Briefly described, the present invention generally relates to a robot for lifting and delivering an object. More particularly, according to an exemplary embodiment, a robot is disclosed having a receiving surface for receiving and holding an object. A vertical movement mechanism lowers and raises the receiving surface. In some embodiments, the vertical movement mechanism is a scissor lift type device. A mobile platform connects the receiving surface and the vertical movement mechanism to move the receiving surface to an appropriate location.

In an exemplary embodiment, a robot has a receiving surface for receiving and holding an object and a vertical movement mechanism connected to the receiving surface for moving the receiving surface in a vertical direction. The robot can further comprise a mobile base connected to the vertical movement mechanism that can move the robot along a surface. To move the robot, for example, by a user, the robot further comprises a movement control device with a positioning apparatus for inputting a movement command to the mobile base, and a lift command apparatus for inputting a lift command to the vertical movement mechanism to direct the robot to communicate with at least one object on the surface onto a receiving surface of the robot. The robot can further comprise have a first transceiver configured to receive the movement command or the lift command from the movement control device or a computer in communication with the robot.

In other exemplary embodiments, the robot can comprise a sweeping mechanism to communicate with an object, via a sweep, onto at least a portion of the receiving surface. The sweeping mechanism can take various forms. In an exemplary embodiment, the sweeping mechanism can be an “L”-shaped arm pivotably connected to the robot, preferably the receiving surface.

In other embodiments, the robot, when in a mode for extracting an object from a surface, such as a floor, the receiving surface can be oriented, e.g. tilted, at an angle to better provide a smooth transition between the surface upon which an object rests and the receiving surface, or vice versa. Although not limited to this advantage, by tilting the receiving surface, thus creating a smoother transition, the energy required to move the object onto the receiving surface can be lowered and the success rate of the object being moved to the receiving surface can be increased.

In an exemplary embodiment, disclosed herein is a robot for moving an object without applying compression forces to the object. The robot comprises a receiving surface for receiving and holding an object without applying compression forces to the object. The robot also comprises a movement mechanism for moving the receiving surface in a desired direction as well as a sweeping mechanism pivotably connected to the receiving surface for sweeping at least a portion of the object onto the receiving surface. Further, the robot comprises a mobile platform for moving the robot along a surface.

In another exemplary embodiment, described herein is a computer readable storage medium having instructions stored thereon for lifting an object, the instructions comprising moving a receiving surface of a robot into a position proximate to an object and initiating a fetch operation. The fetch operation comprises lowering the receiving surface further proximate to the object, moving a sweeping mechanism into a receive position, moving the receiving surface in at least a first predetermined direction to create a receiving area, and moving the sweeping mechanism into a store position wherein the object is at least partially secured within a boundary on the receiving surface formed at least in part by the sweeping mechanism. The instructions further comprise moving the receiving surface with the object.

In a still further exemplary embodiment, disclosed herein is a robot for raising or lowering an object comprising a generally planar receiving surface for receiving and holding an object, a vertical movement mechanism connected to the receiving surface for moving the receiving surface in a vertical direction, a mobile base connected to the vertical movement mechanism for moving the robot along a surface, and a movement control device. The movement control device comprises a positioning apparatus for inputting a movement command to the mobile base and a lift command apparatus for inputting a lift command to the vertical movement mechanism to direct the robot to extract at least one object on the surface onto a receiving surface of the robot. The robot further comprises a first transceiver configured to receive the movement command or the lift command.

The foregoing summarizes only a few beneficial aspects of the present invention and is not intended to be reflective of the full scope of the present invention as claimed. Additional features and advantages of the present invention are set forth in the following description, are apparent from the description, or learned by practicing the present invention. Moreover, The foregoing summary and following detailed description are exemplary and explanatory, and are intended to provide further explanation of the present invention as claimed.

### BRIEF DESCRIPTION OF THE DRAWINGS

The accompanying drawings, which are incorporated in and constitute a part of this specification, illustrate multiple exemplary embodiments of the present invention and, together with the description, serve to explain the principles of the present invention; and, furthermore, are not intended in any manner to limit the scope of the present invention. Headings provided herein are for convenience only and do not necessarily affect the scope or meaning of the claimed present invention. Wherever possible, the same reference numbers are used throughout the drawings to refer to the same or like elements of an exemplary embodiment.

FIG. 1 illustrates a robot according to an exemplary embodiment of the present invention.

FIG. 2 illustrates a vertical movement mechanism according to an exemplary embodiment of the present invention.

FIG. 3 illustrates a receiving surface and sweeping mechanism according to an exemplary embodiment of the present invention.

FIG. 4 illustrates a change in the retrieval area using a predetermined movement according to an exemplary embodiment of the present invention.

FIG. 5 illustrates a communication pathway according to an exemplary embodiment of the present invention.

FIG. 6 is an exemplary method for retrieving an object according to an exemplary embodiment of the present invention.

### DETAILED DESCRIPTION

The subject matter of the various embodiments is described with specificity to meet statutory requirements. However, the description itself is not intended to limit the scope of the claimed invention. Rather, it has been contemplated that the claimed invention can be embodied in other ways, to include different steps or elements similar to the ones described in this document, in conjunction with other present or future technologies. Although the term “step” may be used herein to connote different aspects of methods employed, the term should not be interpreted as implying any particular order among or between various steps herein disclosed unless and except when the order of individual steps is explicitly required. It should be understood that the explanations illustrating data or signal flows are exemplary. The following description is illustrative and non-limiting to any one aspect.

It should also be noted that, as used in the specification and the claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named. Also, in describing preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” one particular value and/or to “about” or “approximately” another particular value. When such a range is expressed, other exemplary embodiments include from the one particular value and/or to the other particular value. The terms “comprising” or “containing” or “including” mean that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified. To facilitate an understanding of the principles and features of the present invention, embodiments are explained hereinafter with reference to implementation in illustrative embodiments.

In situations in which an object is to be moved from one surface for delivery to a person, or another surface, present methods and systems for doing so typically involve the use of a hand-like device attached to a robot. The conventional hand-like device typically has one or more articulated fingers that are moved into position around an object and, upon being directed to pick up the object, close the fingers around the object and lift the object.

While effective in some instances, the use of articulated fingers has disadvantages. First, in order for the fingers to secure the object within the device, the fingers need to apply compressive forces upon the object. That is, two or more fingers are placed in a position and close the distance between the fingers to a predetermined distance or pressure. The compressive force is the pressure, if measured, the fingers exert on the object. In order to secure the object in the fingers, pressure is applied to the object much like a human hand picks up objects. Compression, though, in the context of picking up small and/or delicate objects is that the pressure applied can damage the object or the object may not have the size, shape or texture that provides for the application of pressure. For example, a pill grabbed by the conventional fingers typically breaks apart because of the pressure exerted on the pill by the fingers. In another example, objects that have a smooth surface cause the conventional fingers to miss their mark by sliding off the surface of the object. Conventional fingers, then, that rely upon compressive forces to move an object can either damage the object by exerting too much compression or will not be able to move the object but not enough compression can be applied to the object to secure the object in the fingers.

The present invention overcomes these disadvantages as it does not perform compression-style lifting. Rather, an object is moved onto a receiving surface for transport and lifting. The present robot uses a receiving surface that of a size and shape to allow the object to be moved onto the receiving surface with little or not compression. In one embodiment, the object is swept onto the receiving surface through the use of a sweeping mechanism. The forces exerted by the sweeping mechanism are generally co-planar to the surface upon which the object rests and are in the general direction of the intended direction of movement of the object onto the receiving surface. Therefore, instead of using compressive forces, in which one or more of the forces applied to object are in a direction generally opposite to the intended direction of movement of the object, the robot of the present invention exerts co-planar, non-compressive forces that are in the general direction of the intended direction of movement of the objection onto the receiving surface.

Generally speaking, the robot of the present invention moves the receiving surface into a position, the receiving surface is moved a position proximate to the object or objects being moved or extracted from a surface. The object is placed onto the receiving surface and thereafter the receiving surface is moved to a desired position, for example by lifting. The robot can also move an object from a higher surface to a lower surface. Instead of requiring compression to maintain control of the object, the object rests on the receiving surface.

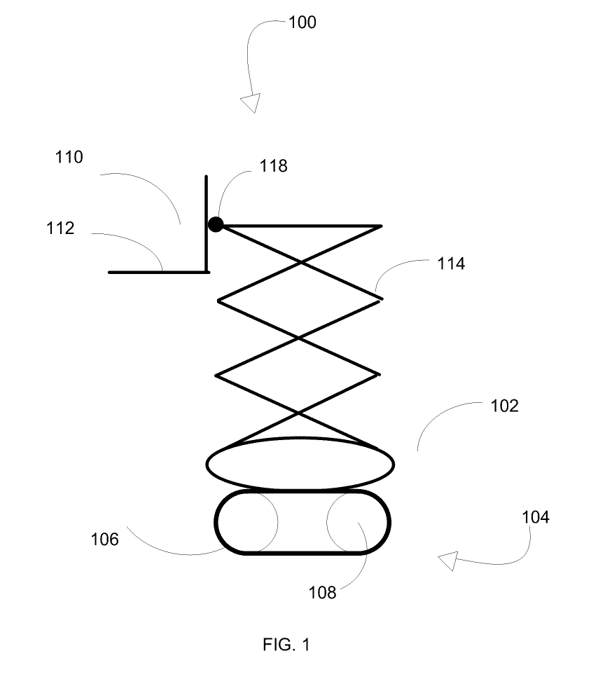

Referring now to the Figures, FIG. 1 is an illustration of an exemplary robot used for lifting an object. Robot 100 has mobile base 102 with mobility mechanism 104 for moving the base along a surface, such as a floor. Mobility mechanism 104 can be a track and wheel configuration with a plurality of wheels 106 surrounded by a track 108. Track 108 is rotated in various ways to turn, stop, rotate, and move mobile base 102. The mobility mechanisms can vary. For example, mobile base 102 can be moved using wheels without tracks or electromagnetic means wherein the mobile base 102 is moved from one point to another using magnetism or electric charges. The present invention accordingly is not limited to any particular type of mobility mechanism, but rather, encompasses all movement mechanisms known or unknown in the art.

As discussed above, an object is lifted using a non-compressive force. Robot 100 further comprises receiving device 110 with a receiving surface 112. generally planar An object (not shown) is manipulated so that at least a portion of the object rests on at least a portion of receiving surface 112. Although in FIG. 1, receiving surface 112 is in a generally planar shape, it should be noted that the receiving surface can have other configurations. Although the present invention refers to receiving surface 112 as being generally planar, receiving surface 112 can have other configurations. For example, when receiving surface 112 is used in ordinance disposal, beyond generally planar, it is preferable that receiving surface 112 have various surface imperfections that deflect explosive forces or allow the explosive forces to pass through the receiving surface. In another example, receiving surface 112 may be partially curved, such as a slight “U” shape, so that an object that is placed on receiving surface 112 moves or slides to the lowest point of the curve, partially securing the object in an intended location.

Mobile base 102 moves receiving surface 112 into a position for fetching an object, i.e. mobile base 102 moves receiving surface 112 in a position proximate to the object. For lowering and lifting receiving surface 112, the robot further comprises vertical movement mechanism 114. Vertical movement mechanism 114 is configured to raise and lower receiving surface 112 to provide for a fetch and lift operation. Vertical movement mechanism 114 allows for the movement of the receiving surface 112 from the floor or surface upon which an object rests to a predetermined height, such as a table or a waiting hand. In the same manner, vertical movement mechanism 113 also allows for the movement of receiving surface 112 from a position of one height to a position of lower height. A scissor lift is used as the vertical movement mechanism 114 in FIG. 1. Other ways in which receiving surface 112 can be raised or lowered are considered to be within the scope of the present application, including a screw-type lift mechanism.

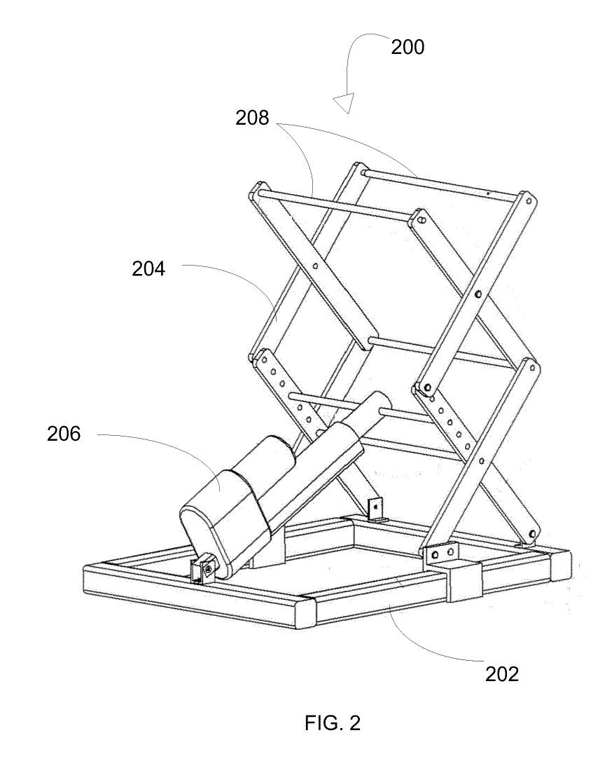

A scissor lift type mechanism, such as vertical movement mechanism 114 of FIG. 1 is shown by way of example in FIG. 2. Mechanism 200 comprises base 202 that is preferably mounted to the mobile base of the present robot, such mobile base 102 of robot 100. To raise or lower a receiving surface, such as receiving surface 112 of FIG. 1, piston 206 moves scissor arms 204. When piston 206 extends its control arm, scissor arms 204 are moved closer together, thus raising the height of the top 208 of scissor arms 204. When piston 206 is retracted, the opposite occurs. A receiving surface is mounted to a portion of scissor arms 204 at various heights depending upon the desired configuration.

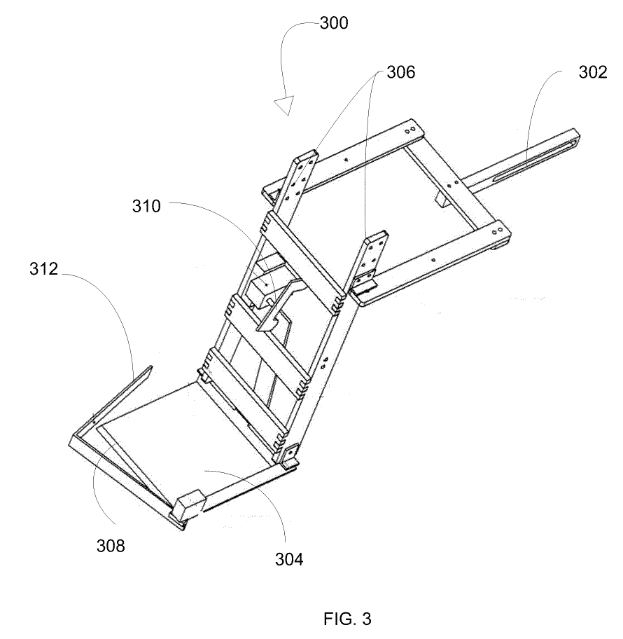

FIG. 3 illustrates an exemplary receiving device 300, such as receiving device 110 of FIG. 1. Receiving device 300 is connected to a vertical lift mechanism, such as mechanism 200 of FIG. 2 via connector arm 302. To provide a platform for securing an object, receiving device 300 comprises receiving surface 304. In the present exemplary embodiment, receiving surface 304 is connected to connector arm 302 via frame 306. Receiving surface 304 can be connected to connector arm 302 via various mechanical means, which are considered to be within the scope of the present invention. Further, receiving surface 304 can be directly connected to a vertical lift mechanism.

In some exemplary embodiments, it may be preferable or necessary to change the angle of the receiving surface 304 in relation to the surface upon which the object rests. By changing the relative angle, a smoother transition between the surface upon which an object rests and receiving surface 304 can be provide. The tilting effect can provide advantageous orientation of a leading edge 308 of receiving surface 304 to the surface upon which the object rests. Leading edge 308 can be beveled to reduce the resistance of movement of the object from the surface upon which it rests to the receiving surface 304. The present invention can further compromise tilting mechanism 310. Tilting mechanism 310 moves receiving surface 304 about a pivot, rotating receiving surface 304 at slight angles. In a non-tilted position, receiving surface 304 is generally parallel to a surface and in a tilted position, receiving surface 304 is at an angle to the surface.

In some embodiments, when receiving surface 304 is ready to receive an object, receiving surface 304 can be moved to slide leading edge 308 under the object to be picked up. Although this may work in some instances, it can be preferable to provide an additional force to move the object onto receiving surface 304. As shown in FIG. 3, sweeping mechanism 312 can be used as this additional force. Sweeping mechanism 312 is pivotably attached to receiving surface 304. When a fetch command is received, in one exemplary embodiment, receiving surface 304 moves into a position proximate to the object or objects to be fetched. Prior to lowering receiving surface 304 onto the surface, sweeping mechanism 312 rotates so that leading edge 308 is exposed to the object. Receiving surface 304, in the present exemplary embodiment, is thereafter lowered onto the surface and, if desired, tilted. In one exemplary embodiment, receiving surface 304 moves a desired or predetermined amount and then sweeping mechanism 312 rotates back to move the object onto the receiving surface. In essence, this provides a barrier to reduce the probability that the object may fall off receiving surface 304. Additionally, in some embodiments, sweeping mechanism 312 can rotate about more than one (1) axis.

Other types of devices or methods may be used to give the additional force provided by sweeping mechanism 312 of FIG. 3. For example, receiving surface 304 can have one or more nozzles of pressurized gas that, when released, direct the object onto receiving surface 304. The present invention accordingly is not limited to any particular type of device or method that provides this additional force, but rather, encompasses all movement mechanisms known or unknown in the art.

The combination of a predetermined or desired movement when receiving surface is ready to receive the object advantageously provides an increased active receiving area. In the current art, the active receiving area is the area in which an object, if located within, can be received. For example, when a person uses their fingers, the active receiving area is the area on the object proximate to the fingertips. In the current art that uses articulated or prehensile fingers, the active receiving area can be increased by increasing the size of the fingertips or the number of fingers. Disadvantageously, increasing the sizes of the fingers (or pressure application mechanisms) and/or increasing the number of fingers to increase the active receiving area can increase production costs as well as increase the complexity of the device, possibly lowering the reliability and longevity of the device.

To increase the active receiving area of the present invention, receiving surface 304 can automatically move a desired length or direction (or directions) to effectively scoop up a larger surface area than what would be provided by using sweeping mechanism 312 alone. By moving receiving surface 304 a desired length, the active receiving area can be adjusted without the need to increase the number of parts of the robot or increase the size of any parts of the robot. This advantageously helps to reduce the complexity of the robot and the size of the robot, thereby increasing the reliability of the robot while achieving a manufacturing cost target.

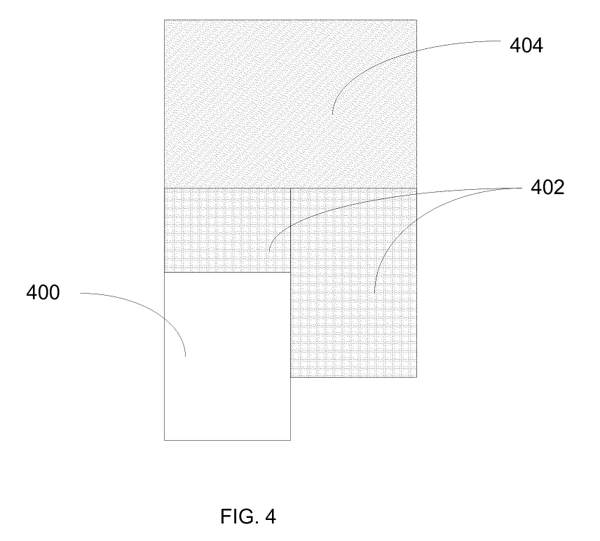

FIG. 4 illustrates how, by moving a receiving area, such as receiving area 400, in a predetermined or desired direction or amount, the active receiving area can be increased. Using a sweeping mechanism alone, the amount of area that an object can reside and can be moved onto receiving surface 400 is indicated by area 402. In other words, if receiving surface 400 is not moved when fetching an object, a sweeping mechanism only would cover area 402. But, if receiving surface 400 is moved, the active receiving area is increased. For example, if receiving surface 400 is moved forward and sideways, the amount of surface covered by the movement alone is represented by area 404. If a sweeping mechanism is used, the active receiving area can be area 402 plus area 404, thus increasing the active receiving area.

Receiving area 400 can also be changed by changing the size of the sweeping mechanism. By using a sweeping mechanism, such as sweeping mechanism 312 of FIG. 3, with an increased length or different design, the amount of area represented by 402 can be increased or decreased as desired. Additionally, more than one sweeping mechanism may be use.

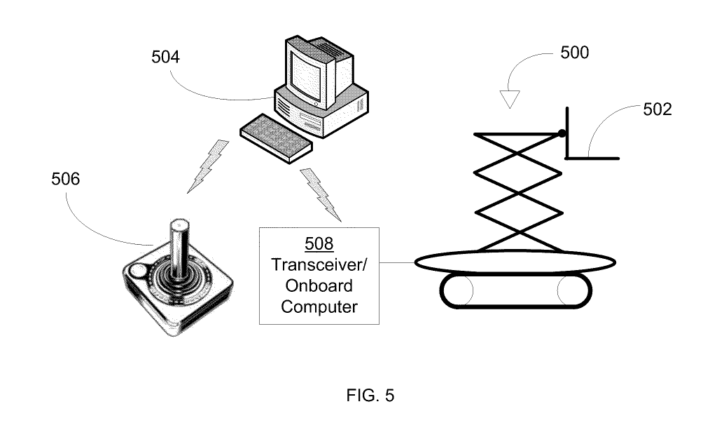

FIG. 5 illustrates an exemplary system for lifting an object from a surface. Robot 500 has receiving surface 502. In some exemplary embodiments, the position of robot 500 can be autonomous, i.e. robot 500 does not receive movement commands from an outside source. Instead, robot 500 determines its position based upon a set of instructions in a program that are preloaded into computer 504 or transceiver/onboard computer 508 of robot 500. In another exemplary embodiment, the position of robot 500 can be determined using an outside control device, such as joystick 506. A user can use joystick 506 which translates movement of the joystick 506 into movement commands for robot 500. Joystick 506 is in communication with computer 504 configured to receive and relay the position instructions from joystick 506 to transceiver/onboard computer 508. Computer 504 can also be used to preload movement instructions onto transceiver/onboard computer 508 for autonomous operation. Additionally, computer 504 can be configured to relay the predetermined movement described in FIG. 4, above, onto transceiver/onboard computer 508. Further, computer 504 can be of various types of electronics, including, but not limited to, a special purpose computer or analogue radio frequency circuit boards.

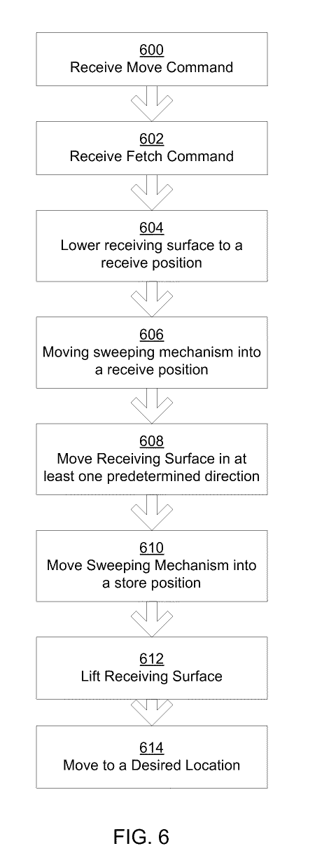

FIG. 6 is an exemplary method embodying instructions loaded onto an onboard computer of a robot according to an exemplary embodiment of the present invention. The instructions can be stored in a computer readable storage medium. By way of example, and not limitation, computer readable storage media can comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or other mediums that can be used to store the desired information and that can be accessed by an onboard computer.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the above also e included within the scope of computer readable media.

Referring back to FIG. 6, a method of lifting an object using a robot comprises a robot first receiving 600 a move command. As discussed earlier, the move command can be inputted by a user manipulating a joystick or can be determined by a preloaded program, or combinations thereof. After the robot moves into the position received in the move command, a fetch command 602 is received. The fetch command can be inputted by a user manipulating a joystick or can be determined by a preloaded program, or combinations thereof. The receiving surface is lowered 604 into a receive position. If a sweeping mechanism is used, the sweeping mechanism can be moved 606 to expose a leading edge of the receiving surface. In addition, if the receiving surface is to be tilted, prior to, after, or in conjunction with step 604, the receiving surface can be tilted.

After the receiving surface is lowered, the receiving surface moves 608 to increase the active receiving area in at least one direction or length. The movement can be for a period of time or can be for a certain length, or combinations thereof. If a sweeping mechanism is used, the sweeping mechanism moves 610 into a store position. At this point, at least a portion of the object is preferably resting on the receiving surface. The sweeping mechanism can be configured to help secure the object on the receiving surface. Either in conjunction with, before or after step 610, the receiving surface is lifted 612. After the object is lifted 612, the robot moves to a desired location 614. It may be desired to stop all movement of the robot, including the receiving surface. In such instances, the method can further comprise an emergency stop command for stopping all movement of the robot. This can be used, by way of example, if the user determines that the movement of the robot is insufficient or undesired.

Finally, while the present disclosure has been described in connection with a plurality of exemplary embodiments, as illustrated in the various figures and discussed above, it is understood that other similar embodiments can be used or modifications and additions can be made to the described embodiments for performing similar functions of the present invention without deviating therefrom. Therefore, the present invention should not be limited to any single embodiment, but rather construed in breadth and scope in accordance with the following claims.

What is claimed is:

1. A robot for moving an object without applying compression forces to the object, the robot comprising:
a receiving surface for receiving and holding an object without applying compression forces to the object;
a movement mechanism for moving the receiving surface in a desired direction;
a sweeping mechanism pivotably connected to the receiving surface for sweeping at least a portion of the object onto the receiving surface; and
a mobile platform for moving the robot along a surface.

2. The robot of claim 1, wherein the receiving surface is a generally planar receiving surface and wherein the movement mechanism vertically moves the generally planar receiving surface.

3. The robot of claim 1, further comprising an orientation mechanism for orienting the receiving surface prior to receiving at least a portion of the object.

4. The robot of claim 3, wherein the orientation mechanism comprises a tilting mechanism.

5. The system of claim 3, wherein the orientation mechanism substantially levels the receiving surface when the at least a portion of the object has been received onto the receiving surface.

6. The robot of claim 1, wherein the mobile platform is activated to move by a user of the robot.

7. The robot of claim 1, wherein the predetermined movement is a set length of movement or set time of movement.

8. A computer readable storage medium having instructions stored thereon for lifting an object, the instructions comprising:
moving a receiving surface of a robot into a position proximate to an object;
initiating a fetch operation, wherein the fetch operation comprises:
lowering the receiving surface further proximate to the object;
moving a sweeping mechanism into a receive position;
moving the receiving surface in at least a first predetermined direction to create a receiving area; and
moving the sweeping mechanism into a store position wherein the object is at least partially secured within a boundary on the receiving surface formed at least in part by the sweeping mechanism; and
moving the receiving surface with the object.

9. The computer readable storage medium of claim 8, wherein the fetch operation further comprises orienting the receiving surface so that at least a portion of an edge of the receiving surface contacts a surface upon which the object resides.

10. The computer readable storage medium of claim 9, further comprising substantially leveling the receiving surface after moving the sweeping mechanism into the store position.

11. The computer readable storage medium of claim 8, wherein moving the receiving surface in at least a first predetermined direction to create a receiving area further comprises moving the receiving surface in at least a second predetermined direction in conjunction with the first predetermined direction.

12. The computer readable storage medium of claim 8, further comprising instructions for emergency stopping the receiving surface.

13. The computer readable storage medium of claim 8, wherein moving a generally planar receiving surface is not initiated if the receiving surface is at the determined height.

14. A robot for raising or lowering an object, comprising:
a generally planar receiving surface for receiving and holding an object;
a vertical movement mechanism connected to the receiving surface for moving the receiving surface in a vertical direction;
a mobile base connected to the vertical movement mechanism for moving the robot along a surface;
a movement control device comprising:
a positioning apparatus for inputting a movement command to the mobile base; and
a lift command apparatus for inputting a lift command to the vertical movement mechanism to direct the robot to extract at least one object on the surface onto a receiving surface of the robot; and
a first transceiver configured to receive the movement command or the lift command.

15. The robot of claim 14, further comprising a tilting mechanism for tilting the generally planar surface when receiving at least a portion of the object.

16. The robot of claim 15, wherein the tilting mechanism is configured to substantially level the receiving surface when the at least a portion of the object has been received onto the receiving surface.

17. The robot of claim 14, further comprising a sweeping mechanism pivotably connected to the receiving surface for sweeping at least a portion of the object onto the receiving surface.

18. The robot of claim 14, wherein the vertical movement mechanism is a scissor lift or a screw lift.

19. The robot of claim 14, wherein the positioning apparatus is a joystick.

20. The robot of claim 14, wherein the mobile platform is configured to have a predetermined movement when a user issues a command to fetch the object, wherein the predetermined movement is a set length of movement or set time of movement.
